(19) United States
(12) Patent Application Publication
(10) Pub. No.: US 2011/0302012 A1
(43) Pub. Date: Dec. 8, 2011

(54) SYSTEM AND METHOD FOR REDEEMING COUPONS

(75) Inventors: Christian R. Duroux, Paris (FR); Alexandre J. Duroux, Paris (FR)

(73) Assignee: CASHKLICK INC., Santa Clara, CA (US)

(21) Appl. No.: 13/198,522

(22) Filed: Aug. 4, 2011

Related U.S. Application Data
(63) Continuation-in-part of application No. 12/944,005, filed on Nov. 11, 2010.
(60) Provisional application No. 61/262,219, filed on Nov. 18, 2009.

(51) Int. Cl. G06Q 30/00

(52) U.S. Cl. 705/14.17; 705/14.26

(57) ABSTRACT

A system and method for redeeming coupons including a base station providing a user redeemable coupon account for a user and a redeemable coupon feeding provider server coupled to the base station for delivering a redeemable coupon to the base station and into the account of the user. When the user presents a redeemable coupon for purchase of a product or service at a point of sale, such as a retailer, wholesaler or on-line merchant after verification by said base station that said coupon is associated with said retailer, wholesaler or on-line merchant and after verification by said retailer, wholesaler or on-line merchant that said coupon is associated with said purchase, the redeemed coupon is sent from said retailer, wholesaler or on-line merchant to the base station. Any suitable mobile-type payment, such as a debit or credit card, a Google wallet, a Visa Mobile payment, etc. may be used. The debit or credit card may be a prepaid card, a co-branded card, etc. The base station may be managed by an acquirer/processor or a financial institution and the system and method herein can be used with an on-line or brick and mortar retailer.

### CROSS-REFERENCE TO RELATED APPLICATIONS

This application is a continuation-in-part and thus claims the benefit of and priority to U.S. patent application Ser. No. 12/944,005, filed Nov. 11, 2010, which claimed the benefit of and priority to U.S. Provisional Application Ser. No. 61/262,219 filed Nov. 18, 2009, the contents of which are incorporated by reference herein in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

### 1. Field

The invention relates to a system and method for providing discount coupons to a user redeemable for a discount or the like for products or services at a retail or wholesale location.

2. Description of Related Art Including Information Disclosed Under 37 C.F.R. 1.97 and 1.98

Coupons offering discounts off of goods or services are very popular, but require a user to print it out, remember to take it to the market or other point of sale, and involves a transaction with the cashier at the market to obtain a discount.

Thus, the conventional use of coupons by consumers involves cutting paper coupons out of a newspaper or magazine, printing them out at a website, and keeping them in one's wallet. This is cumbersome, and typically involves complicated procedures during the coupon redemption process.

### BRIEF SUMMARY OF THE INVENTION

It is an object of this invention to provide a coupon redemption system and method for conventional and online retailers and wholesalers.

It is a further object of this invention to provide such a coupon redemption method and system allowing such merchants to accept redeemable coupons through debit and credit cards and other payment cards such as prepaid cards.

These and other objects are accomplished by providing a coupon redemption system and method allowing an end user to apply coupons, which are associated to his/her credit or debit card during a wholesale or retail transaction checkout, without providing any paper form of coupons or any other user or merchandise information. The system and method herein automates and expedites the coupon redemption for the retailers and/or wholesalers.

The system and method herein contemplates use of a service provider which receives promotion data from a coupon feeding provider. The coupons can be redeemed at locations through a service provider network.

Coupon settlement on behalf of the retailers or wholesalers is provided through the coupon settlement provider. The system and method herein assists merchants in avoiding coupon fraud and illegal coupon redemption. In addition, a real time update for end-users, coupon feeding providers, and Retailers and Coupon Settlement Providers is provided.

### BRIEF DESCRIPTION OF THE SEVERAL VIEWS OF THE DRAWINGS

FIG. 1 is a schematic illustration showing a flow diagram of the system and method of the invention;

FIG. 2 is a schematic illustration of the architecture of the invention;

FIG. 3 is a schematic illustration of high level system collaborations of the invention;

FIG. 4 is a schematic illustration of the participants in the system and method of the invention;

FIG. 5 is a schematic illustration showing how the coupons are entered into the system and method of the invention;

FIG. 6 is a schematic illustration of the various packages comprising the system and method of the invention;

FIG. 7 is a schematic illustration of the significant entities of the system and method of the invention showing their attributes and relationships;

FIG. 8 is a schematic illustration of how a coupon moves from one state to another in the system and method of the invention;

FIG. 9 illustrates schematically how coupons are loaded into the system and method of the invention;

FIG. 10 is a schematic overview of the redemption of a companion the system and method of the invention;

FIG. 11 is a schematic illustration of how coupons are qualified for redemption in the system and method of the invention;

FIG. 12 schematically illustrates how a coupon is redeemed in the system and method of the invention;

FIG. 13 schematically illustrates the deployment of various components of the system and method of the invention;

FIG. 14 illustrates schematically the operation of the various components deployed into multiple servers of the system and method of the invention;

FIG. 15 schematically illustrates the interface of the social network application server with the other servers in the system and method of the invention;

FIG. 16 schematically illustrates the responsibility of each layer in the system and method of the invention;

FIG. 17 illustrates schematically the make-up of the domain layer in the system and method of the invention;

FIG. 18 illustrates schematically the make-up of the persistence layer in the system and method of the invention;

FIG. 19 illustrates schematically the make-up of the service layer in the system and method of the invention;

FIG. 20 is a schematic illustration of the network topology of the system and method of the invention.

FIG. 21 is a schematic view of CKS system;

FIG. 22 is a schematic illustration of the Core Master Database synchronizing with the Core Slave Database;

FIG. 23 is a schematic illustration of the main components of the Core Master System;

FIG. 24 is a schematic illustration of the deployment topology of the Core Master System;

FIG. 25 is a schematic illustration of the main components of the Core Master System;

FIG. 26 is a schematic illustration of the deployment technology of the core Slave System; and

FIG. 27 is a schematic illustration of DATA Synch-Up between the Core Master Database and the Core Slave Database.

### DESCRIPTION OF THE PREFERRED EMBODIMENT

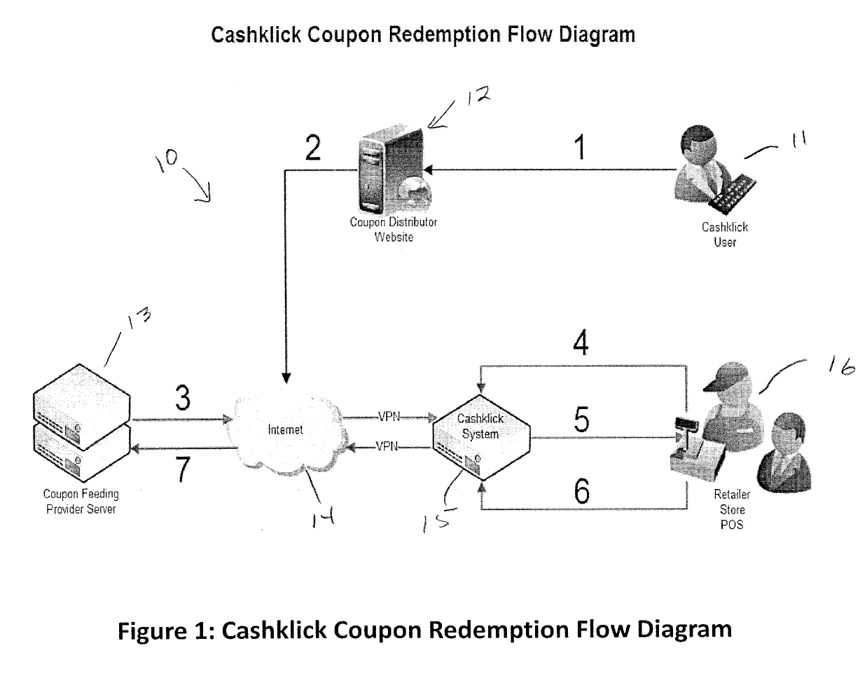

Referring now to FIG. 1 of the drawings, a flow diagram 10 is shown of a coupon redemption system and method in accordance with the teachings of the invention. In the figure of the drawing, CASHKLICK and CKS (abbreviation for CASHKLICK) are trademarks of Cashklick Inc. of Sunnyvale, Calif., assignee of all right, title and interest in and to the subject matter of this application.

Thus, in diagram 10, the following transactions occur:

1. Cashklick (CKS) user 11 maintains a new coupon in his or her Cashklick account received from a coupon distributor website 12.

2. Coupon publisher requests coupon for user from coupon feeding provider server 13.

3. The provider's system sends user the requested coupon(s) over the internet 14 via a virtual private network (VPN) to CKS's system 15 of the invention.

4. User slides his or her registered debit or credit card at a retailer store 16 or other Point of Sale (POS). POS sends coupon request to the CKS system 15.

5. CKS system 15 seeks qualified coupons from user's account and downloads to POS at the retailer store 16.

6. POS at retailer store 16 processes the coupon, and sends coupon status indication “redeemed” back to CKS system 15.

7. CKS system 15 sends the redeemed coupon with “Redeemed” back to the coupon provider's system.

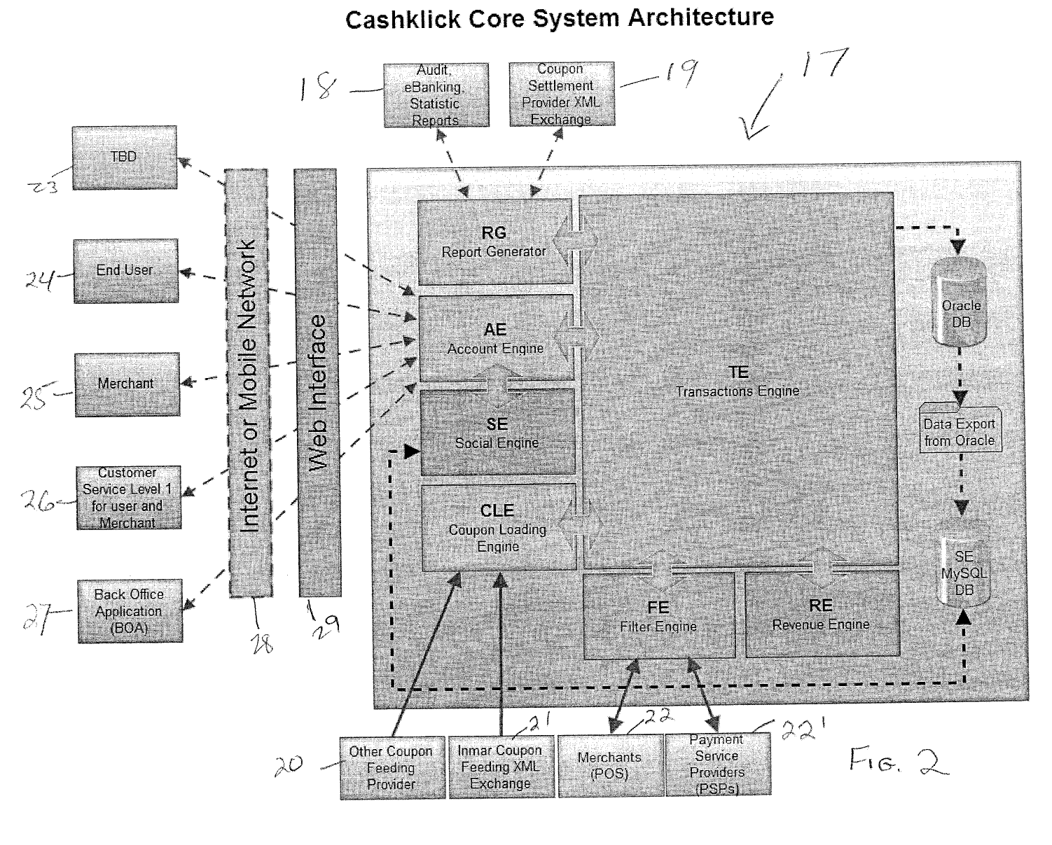

A proposed CKS core system architecture is illustrated in FIG. 2. Layout 17 shows the interface between the basic core system of the invention. The transaction engine interfaces with the Filter engine, Revenue engine, Coupon loading engine, Social engine, Account engine and Report Generator. The transactions engine also interfaces with a database (DB), such as an Oracle® database, which also exports data to a social engine (SE) database (interface) back to the Social Engine of the system as shown. The Report Generator interfaces with the audit, eBanking, Report, Statistic Reports (box 18) and the Coupon Settlement Provider XML Exchange (box 19). The Coupon Loading Engine interfaces with Other Coupon Feeding Providers (box 20) and a suggested well known coupon provider for system 10, such as Inmar® (see Feeding XML Exchange—box 21). The Filter Engine interfaces with the Merchants at Point of Sale (POS)—box 22, and Payment Service Providers (PSPs)—box 22.

As seen to the left in FIG. 2, various participants, such as participants-to-be-determined (box 23), end users (box 24), merchants (box 25), Customer Service Level 1 for user and merchant (box 26) and Back Office Application BOA (box 27) may interface with the Account Engine through an Internet mobile network (box 28) and web interface (box 29).

The system described in FIG. 2 may take other forms and variations thereof would be well within the skill of an artisan.

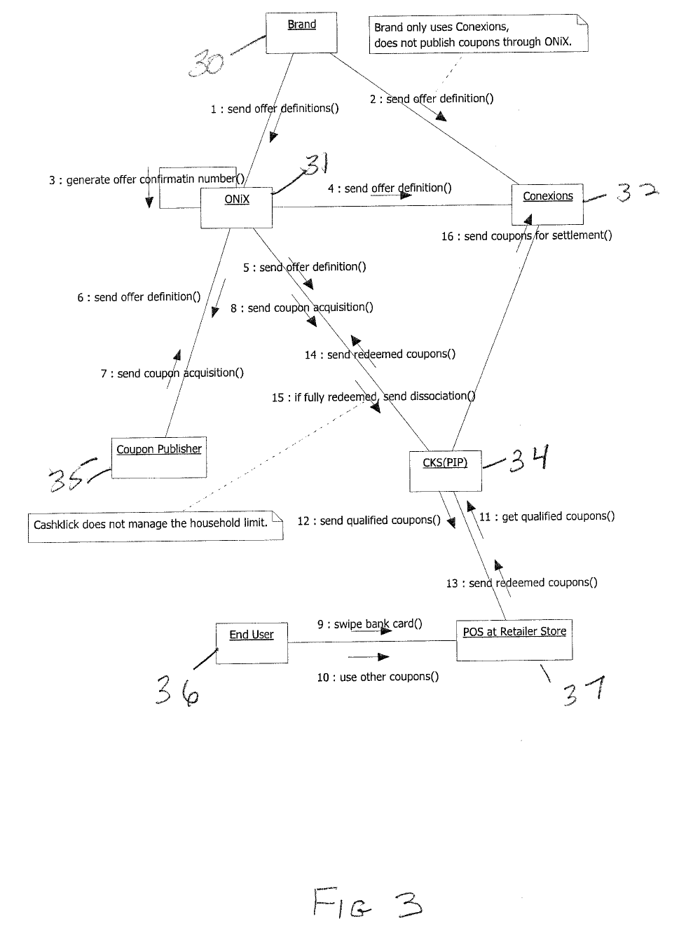

Suggested high level system collorations among various systems involved in the business process are illustrated in FIG. 3.

For example, a brand provider sends a coupon offer (items 1, 2) to a well known coupon providers network ONIX® and a well known coupon settlement platform CONEXIONS® (boxes 31, 32). (Alternatively, the Brand Providers may only deal with the coupon settlement platform). An offer confirmation number (item 3) is generated at box 31 and sent to box 32 (item 4). An offer definition (item 5) is also sent from box 31 to the CKS system PIP (box 34), PIP indicating the Point of Sale Integration Provider. The generator of the offer confirmation number at box 31 also sends (item 6) the information to the coupon publisher, box 35, and the publisher in turn (item 7) at box 35 sends the coupon acquisition back to the generator of the offer confirmation number (at box 31).

The generator at box 31 sends the coupon acquisition (item 8) back to CKS (box 34). Meanwhile, the End User (box 36) swipes his or her card, item 9, at the Retailer Store (box 37) and/or uses other coupons (item 10) at the Store of box 37.

The Retailer Store (box 37) in turn requests a verified qualified coupon (item 11) from CKS (box 34) and CKS verifies that the user has redeemable coupon in his/her account that matches with the Retailer Store 37. CKS then sends the verified qualified coupon, item (12), back to the Retailer Store (box 37). The Retailer Store 37 verifies that the redeemable coupon presented by the user is associated with a purchase made by the user at the Retailer Store 37. The Retailer Store 37 then sends redeemed coupon, item (13), back to CKS (box 34). CKS, (at box 34), sends the redeemed coupons, item (14), back to the offer confirmation number generator at box 31, and, if the coupon is fully redeemed, sends a dissociation indication, item 15 back to CKS (box 34). CKS then sends the coupons back to the service settlement provider for settlement at box 32 (section 16).

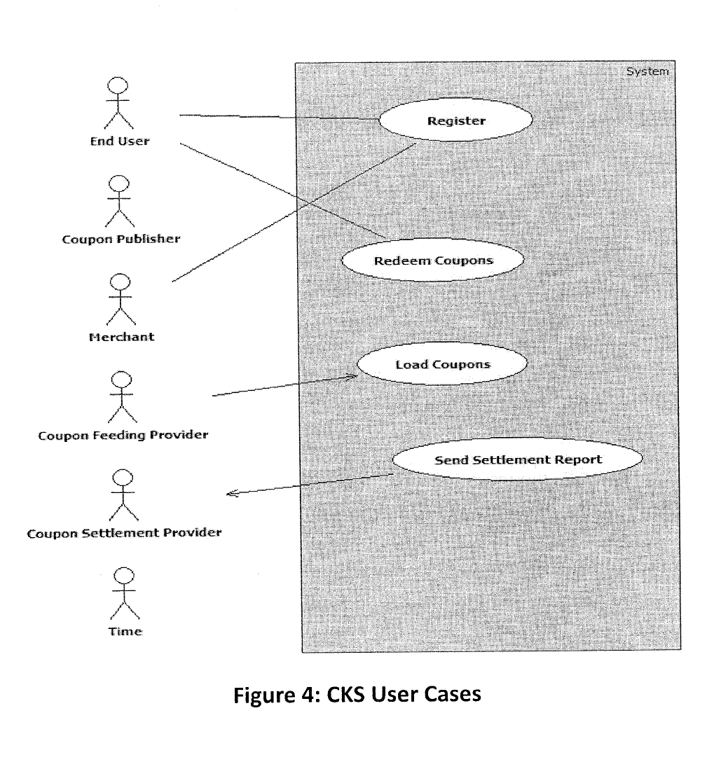

FIG. 4 illustrates CKS's User Cases.
End User: End users register on the Cashklick system, load digital coupons from various coupon publisher web sites and redeem coupons at merchants affiliated with Cashklick.
Coupon Publisher: Coupon Publishers publish digital coupons on their web sites or mobile application. End users visit those websites or applications to add digital coupons into their CKS account.
Merchant (Retailer): Merchants register on Cashklick system. After the approval by CKS administrator, merchants can redeem digital coupons through Cashklick system. Merchants can be either directly connected to CKS or connected to CKS through a Payment Service Provider (PSP) or Acquirer.
Coupon Feeding Provider: Coupon Feeding Providers will receive and/or distribute coupons from/across various coupon publishers' web site. End Users select coupons on the web sites and add them to their Cashklick account. Coupon Feeding Provider sends coupon detail information with Cashklick user ID to Cashklick system.
Coupon Settlement Provider: Cashklick sends settlement report to settlement providers for financial settlement.
Time: Some potential use cases may be triggered by time.

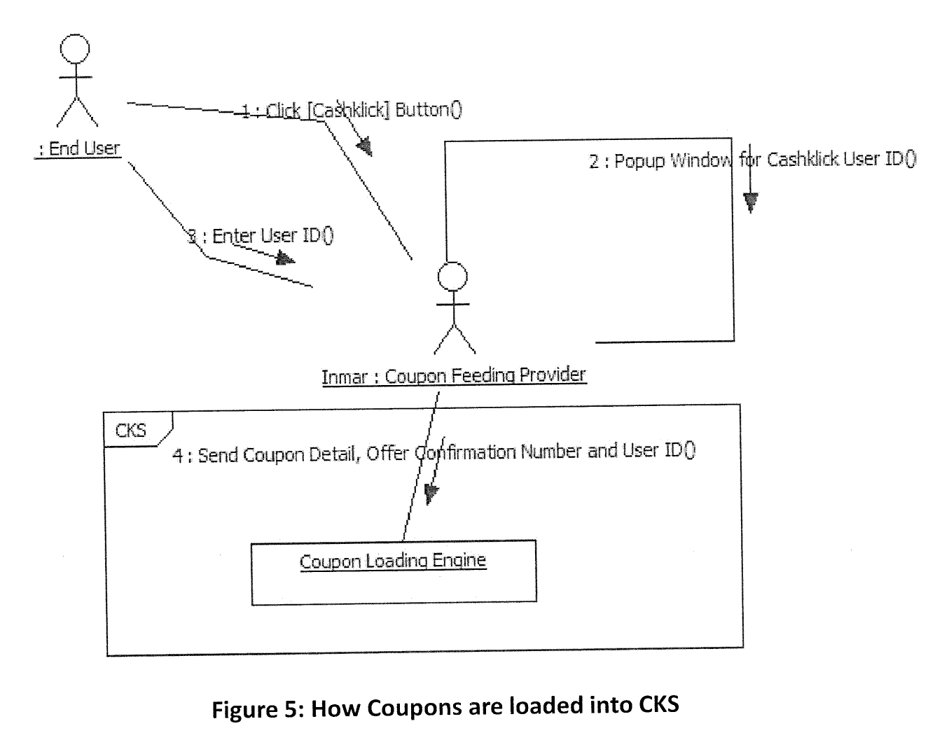

FIG. 5 illustrates How Coupons are loaded into the CKS system.

1. An end user visits a coupon publisher's web site or mobile application, clips a coupon and selects CKS for redemption by clicking the CKS button or by selecting CKS in a drop down menu. Alternatively this process can be automated by embedding a dedicated CKS application into the Publisher's website or mobile application.

2. A dialog pops up asking for the user's Cashklick user ID. The Cashklick user ID can be the user's email address.

3. The user enters his Cashklick user ID into the dialog box and clicks a confirm button.

4. The Coupon Feeding Provider, such as INMAR®, sends the user's Cashklick user ID and selected coupon to CKS.

This procedure can be applied for one coupon or several coupons at a time.

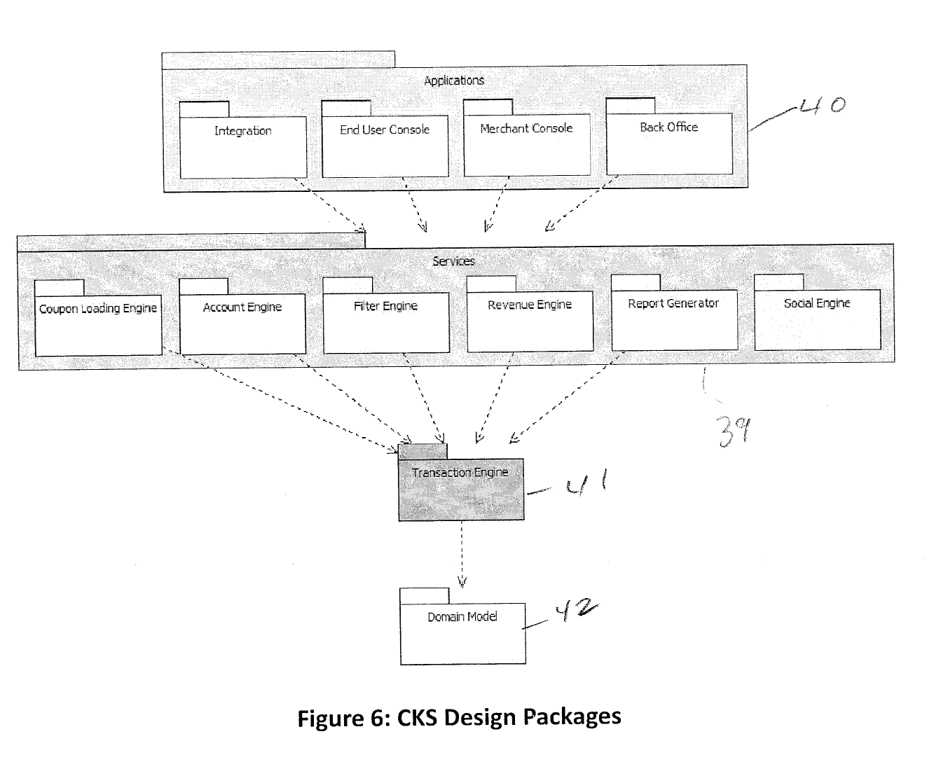

The CKS system is composed of the packages illustrated in FIG. 6.

4.1.1 Services

The services package in box 39 is the core system that implements all business logic and is exposed to applications so that the applications can focus on user interface or integration with other systems and do not need to care too much of the core business logic.

6 major services are defined for the CKS system.

4.1.1.1 Coupon Loading Engine (CLE)

CLE handles the coupon feeding from coupon feeding providers. Before the CLE masters coupon database through Transaction Engine (TE), CLE will validate the received coupon and deposit the new valid coupon to the coupon database.

4.1.1.2 Account Engine (AE)

AE provides services to support the account management functionalities for end user console and merchant console.

4.1.1.3 Filter Engine (FE)

FE is carrying a dual role. It will be connecting to the retailer POS/ePOS or to the PSP/Acquirer and connecting to TE for coupon query. FE will take request from POS/ePOS or from PSP and request a user's coupons from TE. TE will reply with all relevant coupons owned by the users to FE. FE will only select the coupons which are matched to the requestor (retailer or PSP). The final selected coupons will be sent to POS. In addition, the FE will wait for the coupon redemption status from retailer's POS/ePOS or PSP.

As soon as FE received the coupon status from POS/ePOS or PSP, FE will send new coupon's status back to TE for final coupon status change. TE also request CLE to reply to Coupon Feeding Provider (e.g.: Onix®) with the coupon's final status.

4.1.1.4 Revenue Engine (RE)

The role of the RE is to record every single income generated from coupon feeding providers, coupon settlement providers, PSPs/Acquirers and merchants. Recorded information can be used for billing and accounting.

4.1.1.5 Report Generator (RG)

RG is responsible to all report requests. RG will send a specific query request to transaction engine. Transaction Engine will process and reply the query result to RG. RG will render the result to proper report layout.

4.1.1.6 Social Engine (SE)

SE provides a social network style application function for Cashklick users. It is similar to RSS messages broadcasting technology. SE holds all user's friends list and friends' latest coupons activities. If any user's friends added a new coupon, the friend's picture with name and coupon information will be posted to user's friend activities panel. It is like a RSS feeding. Also, some typical social network functions are available in user's friend panel. The web widget style plug-in is added to the end-user account screen.

The applications' Box 40 illustrates that the various packages with different responsibilities are contained in the application package. In general, they are providing user interface for core system or integrated to other sub-systems.

4.1.2.1 Integration

The integration package includes all applications for connecting external and 3rd party systems to CKS, including POS integration, e/POS integration, PSP/Acquirer integration, coupon feeding provider integration and coupon settlement provider integration.

4.1.2.2 End User Console

End user console is the main user interface for end user on CKS. The major function of the end user console is to provide web based account information access, and handle user profile management requests. The end user console only accepts registered users access. In the account management area, regular users can view their coupon collection and coupon status, such as the coupon expiration date, coupon value, coupon redemption status, etc. Also, the regular user account management will be in social network client style.

4.1.2.3 Merchant Console

Merchant console is the main user interface of retailers on CKS. Retailers can view their coupon redemption status and settlement report submission status and create/manage coupon campaign in the account management area.

4.1.2.4 Back Office

Back Office provides the system management and business management functionalities of CKS.

The Transaction Engine box 41 provides an interface to the core database. All other modules in the system must interact with the transaction engine (TE) in order to read data from and write data to the core database. TE and core database are completely shielded in a protected environment. Only modules in the services package can access the TE.

The Domain Model box 42 describes various entities involved in the system and their relationships. In CKS, the major entities are profile, account, coupon, etc.

FIG. 7 conceptually illustrates the significant entities, their attributes and the relationships among them and is self-explanatory.

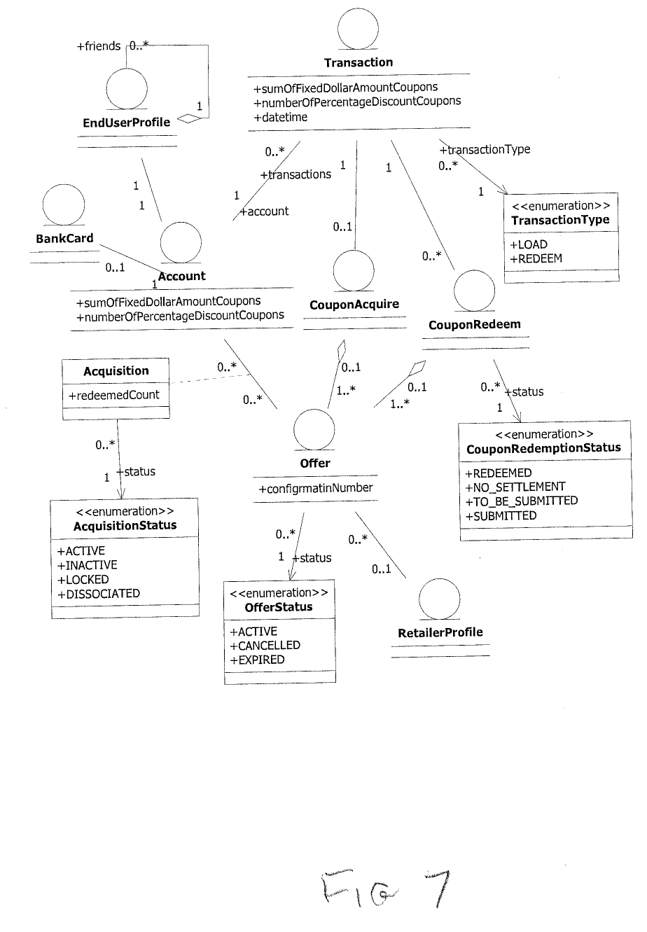

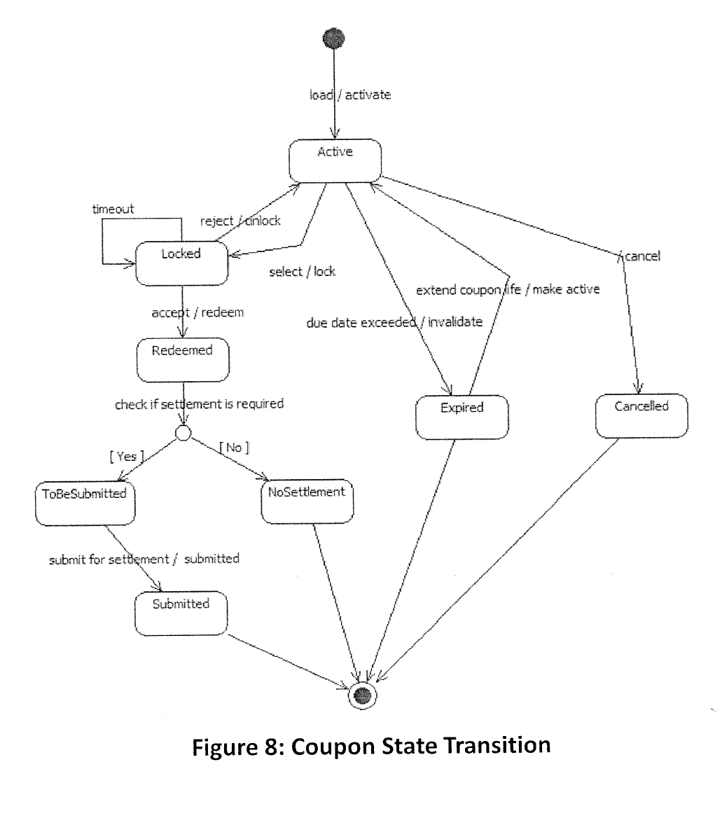

FIG. 8 illustrates the full life cycle states for a coupon and on what conditions a coupon transits from one state to another.

Thus, FIG. 8 illustrates how the software actually works by giving a few selected use-case (or scenario) realizations, and explains how the various design model elements contribute to their functionality.

A coupon loading captures how coupons are loaded into the system by a coupon feeding provider. This diagram is also self explanatory.

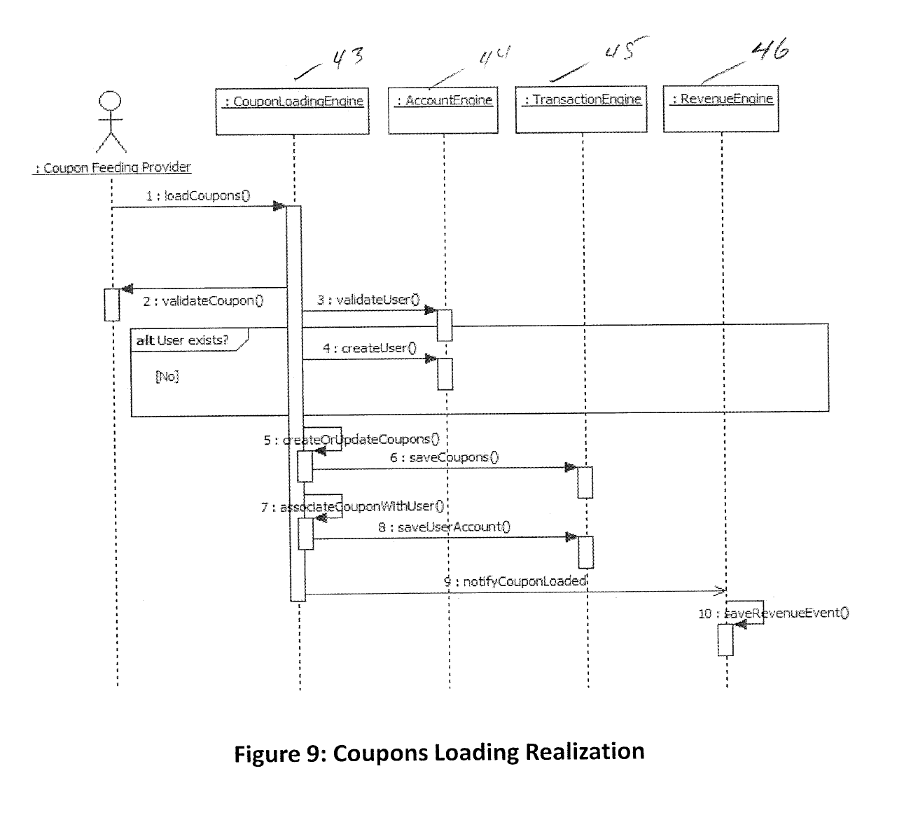

FIG. 9 illustrates how the process starts from the coupon feeding provider to initiate a coupon loading process to CKS, and load coupons into CKS.

The Coupon Loading Engine CLE is mainly responsible for the realization of use case. CLE interacts with AE for user validation and user creation. CLE interacts with TE for database accessing. After a coupon is loaded, CLE notifies RE to save the revenue event. Note: the coupon feeding provider may not directly communicate to CLE. Instead, it should communicate to an integration module and that module in turn passes the request to CLE.

Redeeming coupons captures the process that coupons are redeemed at a retailer store. This use case includes two main phases: finding qualified coupons and redeeming coupons.

For redeeming coupons, Cashklick can be directly connected to POS/ePOS, receive coupon requests directly from POS/ePOS and send coupon replies directly to POS/ePOS. Another option is to request coupons through a Payment Service Provider (PSP) or Acquirer.

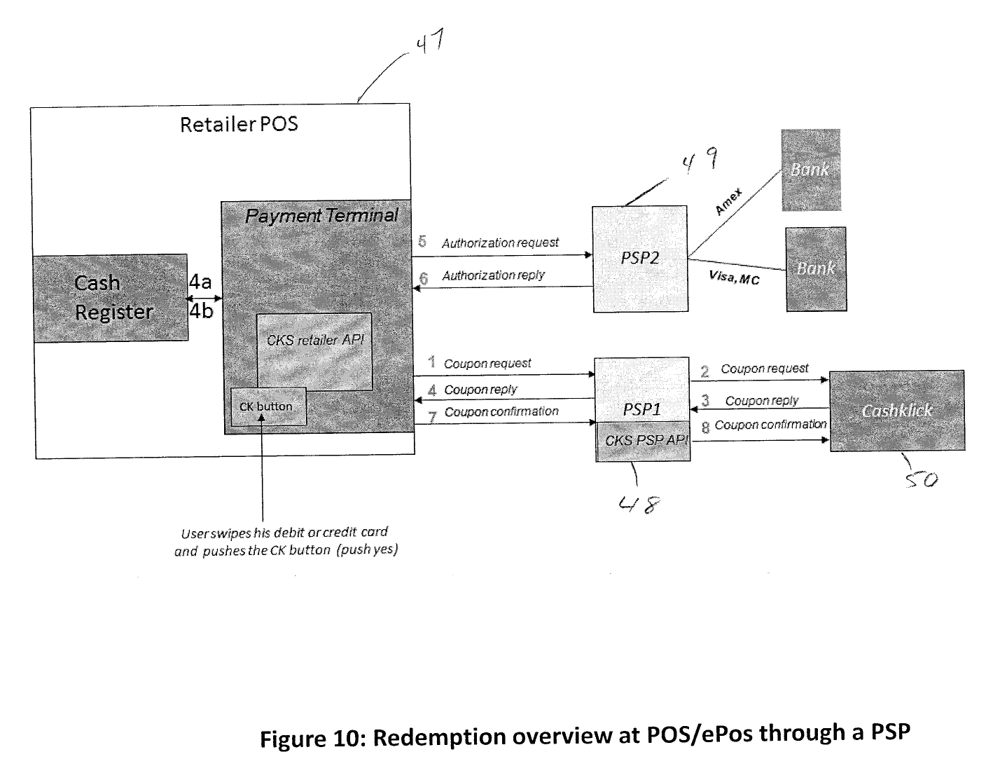

FIG. 10 illustrates how Cashklick redeems coupons at a retailer through a Payment Service Provider (PSP).

Thus, coupons from the provider are loaded at Step 1, validated at Step 2, and the user is validated at Step 3. The user is created at Step 4 and the coupon is created or updated at Step 5. The coupon is saved at Step 6, associated with the user at Step 7, saved to the User's account at Step 8 and the system is notified that the coupon is loaded at Step 9, the revenue generated event saved at Step 10. The system interfaces with the various engines illustrated in boxes 43 through 46. The coupons loading realization illustrated is self explanatory.

FIG. 10 is an overview of the redemption overview at Points of Sale (POS/ePOS) through a Payment Service Provider (PSP).

PSP1 is the PSP partner of CKS, dedicated for coupon redemption only while PSP2 is the PSP that only processes payment. PSP1 and PSP2 may be the same PSP.

1. Coupon Request. Thus, the steps are as follows: CKS retailer API (Box 47) is activated if CKS button is set to ‘yes’ by end user at POS, Another option is to keep the API permanently activated without the use of a CKS button. Payment terminal (Box 47) and PSP1 will issue a transaction ID to be kept active until step 7 is concluded.

End user credit card identification (ISO 1) and original amount of the transaction are uploaded to the PSP1 (Box 48). Other data on the magnetic stripe (or the chip) of the card may also be uploaded if needed.

NB: If CKS button is set to “no”, PSP2 processes the transaction as usual (Box 49). Go to step 5.

2. The PSP1 will generate a coupon request to CKS (Box 50) that includes the credit card identification (encrypted debit/credit card numbers), the original amount of the transaction and the retailer ID.

Filter engine (FE) takes the request and find all qualified coupons that are associated to the customer's credit/debit card number. The FE will be responsible to all process and communication between the PSP connected to the POS/ePOS and Cashklick. All database operations are passed to the Transaction Engine.

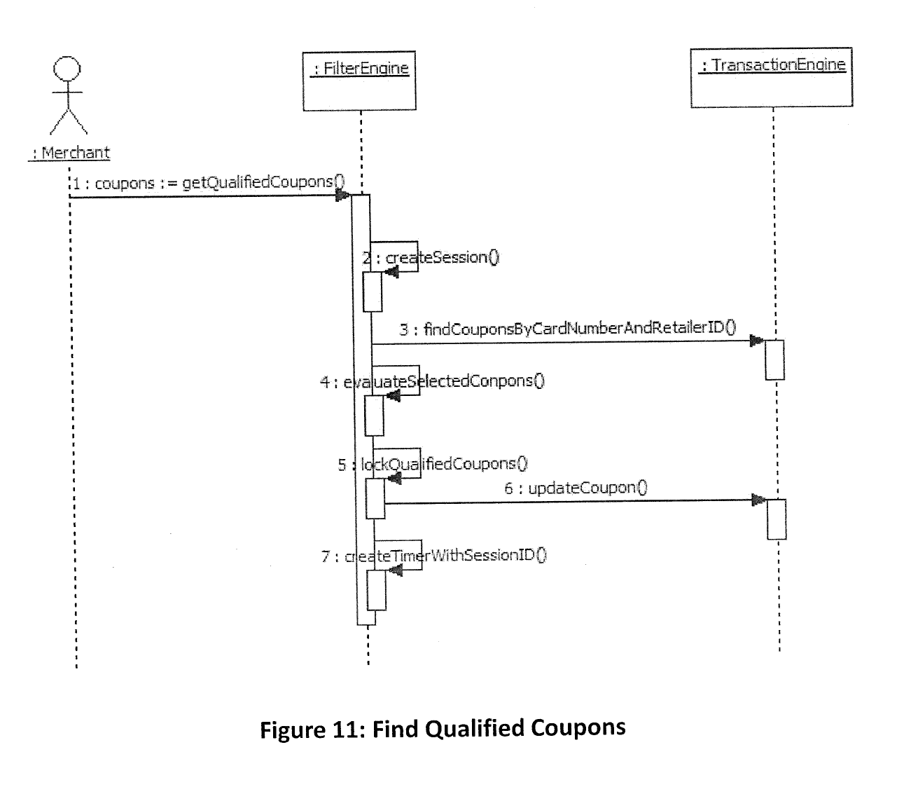

FIG. 11 illustrates how qualified coupons are found.

3. CKS replies to the PSP1 with the list of coupons to be downloaded for redemption.

4. The PSP1 sends the list of coupons to the POS/ePOS Payment terminal.

NB: If coupon=0 or retailer not valid, go to step 5.

4a: Coupons downloaded to POS/ePOS Payment terminal are transmitted to the Cash register application as any coupons scanned locally, etc.

4b: Cash register application computes the new amount of the transaction and reports this new amount with the redeemed coupons report to the Payment terminal.

NB: Step 5 and step 7 may be executed simultaneously.

5. The POS/ePOS payment terminal sends an authorization request to PSP2, as usual, with the new amount of transaction.

6. PSP2 replies to the payment authorization as usual.

NB: If the authorization request is denied: coupons are already redeemed anyway; the end user may pay with another means of payment. The POS/ePOS Payment terminal should not request CKS coupons once again.

7. POS/ePOS Payment terminal sends redeemed coupons report to PSP1.

8. PSP1 uploads redeemed coupon report to CKS.

The FE is then responsible for changing the actual coupons status on the database, and instructs CLE to send coupon disassociation status back to the coupon feeding provider. RE will generate settlement report data for the coupon settlement provider.

FIG. 12 illustrates what occurs if the time between “After the POS/ePOS (through PSP or not) asking for qualified coupons” and “Before POS/ePOS (through PSP or not) and sending back the redeemed coupons” is too long, the session will time out and a notification will be sent to the Back Office for analysis. The illustration is self-explanatory.

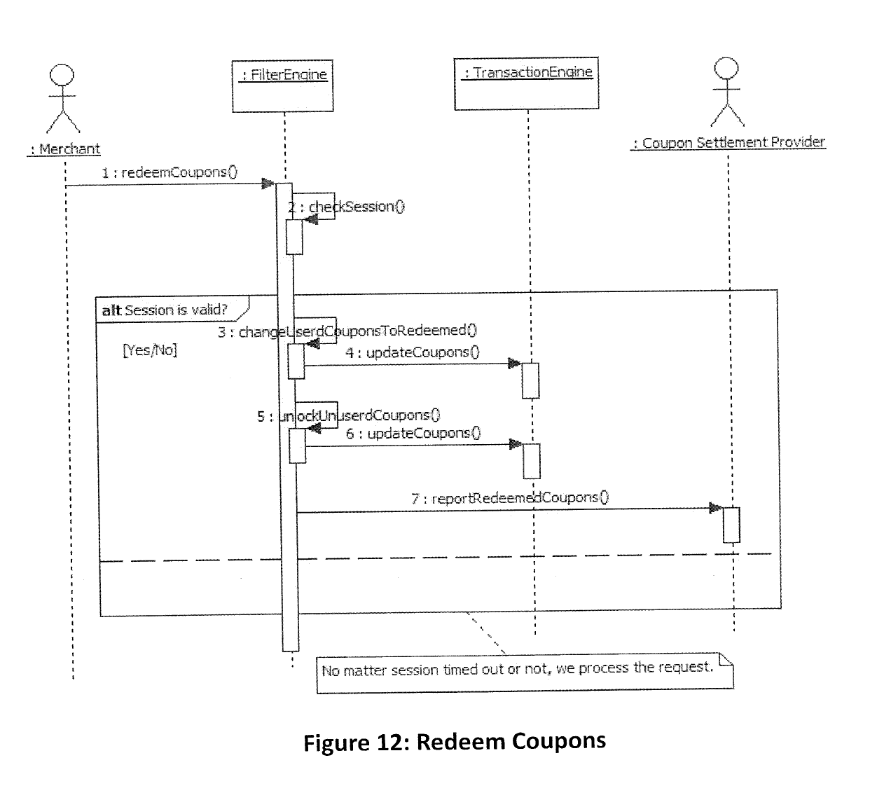

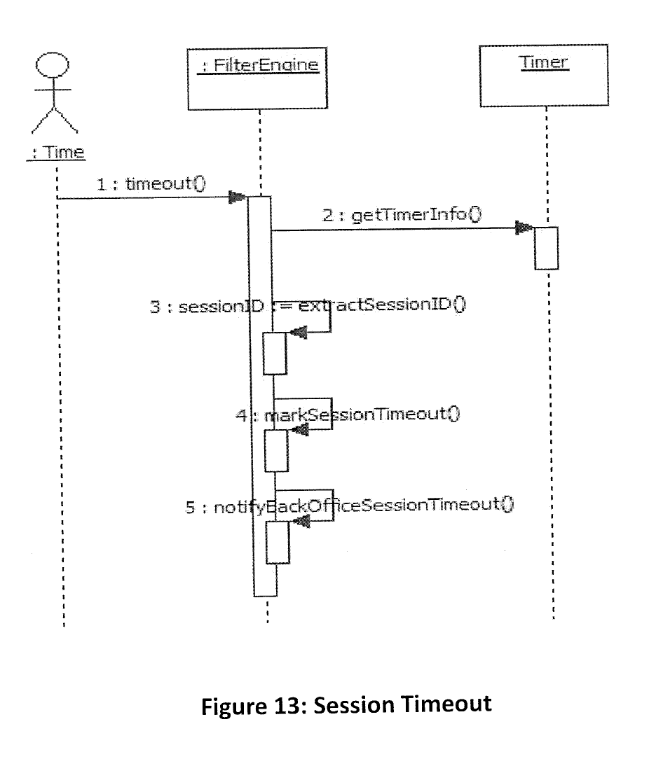

FIG. 13 illustrates how various components in the system are deployed into multiple servers and the communication protocol between servers. Again, the diagram is self-explanatory.

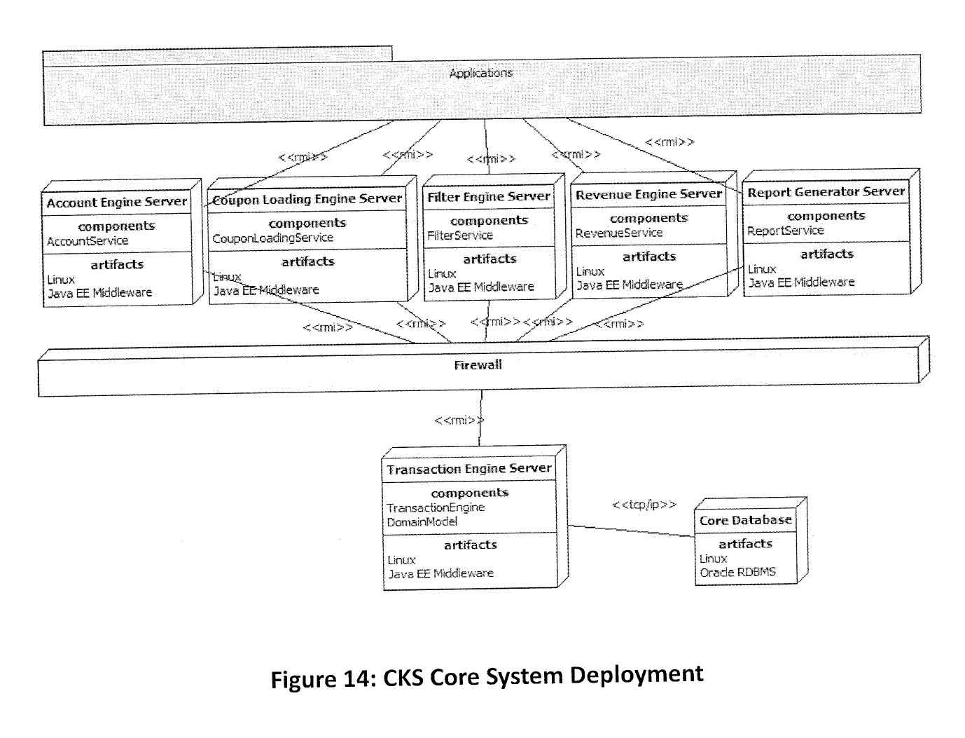

FIG. 14 illustrates the deployment of the CKS core system. The core system includes all components implemented for the core business model, and is not dependent on any other systems. Those modules are responsible for integrating with other systems that are placed into the application package.

The transaction engine (TE) server and core database server are isolated in a protected environment. The transaction server provides database access interface for other services which are resided outside the secure zone. All core service modules access the core database through TE.

The TE server will be clustered to distribute the load. Most frequently read domain objects might be cached and replicated across all nodes in the cluster, so the components that need the domain object need not to go to the database.

All server types can be clustered to scale out to support the increasing loads.

The applications access to the core system for business logic implementation and provide an interface to different users and/or 3^{rd} party systems.

There are specific servers for different purposes. The POS Integration Server hosts the application for integrating to POS clients. The PSP or Acquirer integration Server hosts the application for integrating to PSP or Acquirer. The Coupon feeding provider and coupon settlement provider Integration Server hosts applications that connect these platforms to CKS. The Console Web Server hosts the end user console application and merchant console application.

All server types can be clustered to scale out to support the increasing loads. The diagram is self-explanatory.

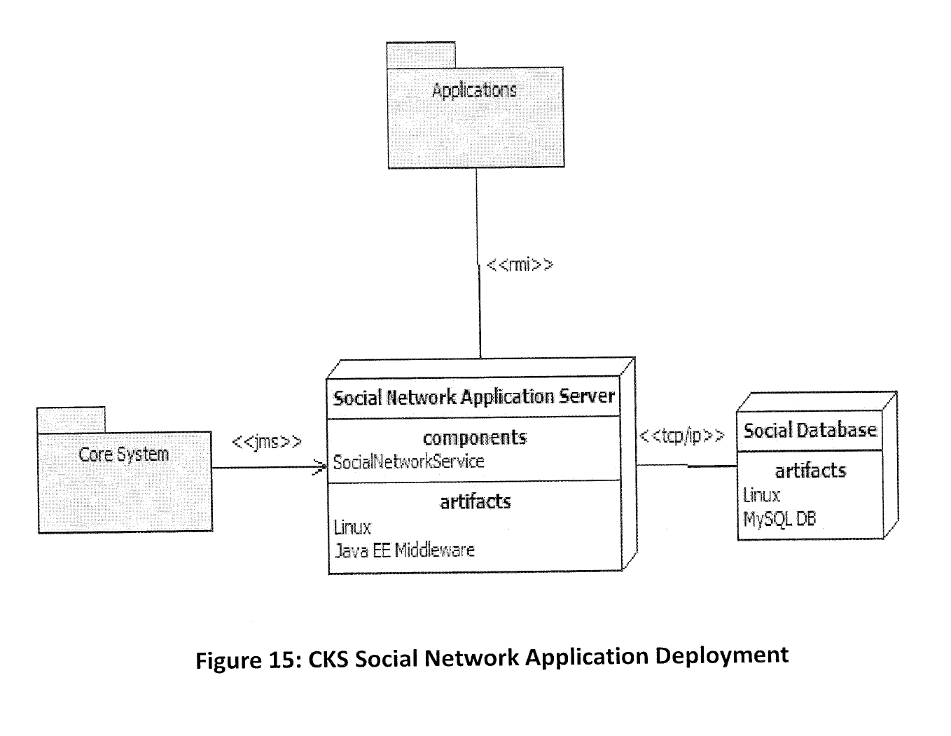

FIG. 15 shows the Social Network Application Server and its relationship with other servers. The social network application does not share the same database with the core system. The Social Network Application Server hosts the component that provides social network related services to the applications—like end user console. The user's coupon activities and events generated from the core system are posted to social network service (SNS) component through the message queue, and the message's contents will be stored to the social network database. Because some data presented in the SNS module are actively running in the core system, and the SNS module is connected to a separated database, the data for SNS database has to be replicated from the core database to the SNS database. The message queue will transport the events contents and data from core database to SNS database.

For example: A user added a coupon to his or her CKS account. The core system will create a message containing the user ID, coupon ID and timestamp, and will notify SNS of this event asynchronously. Then, the SNS can perform further processes without slowing down the core system.

This section describes the decomposition of the system into layers and how the components inside each layer are implemented using the recommended technology.

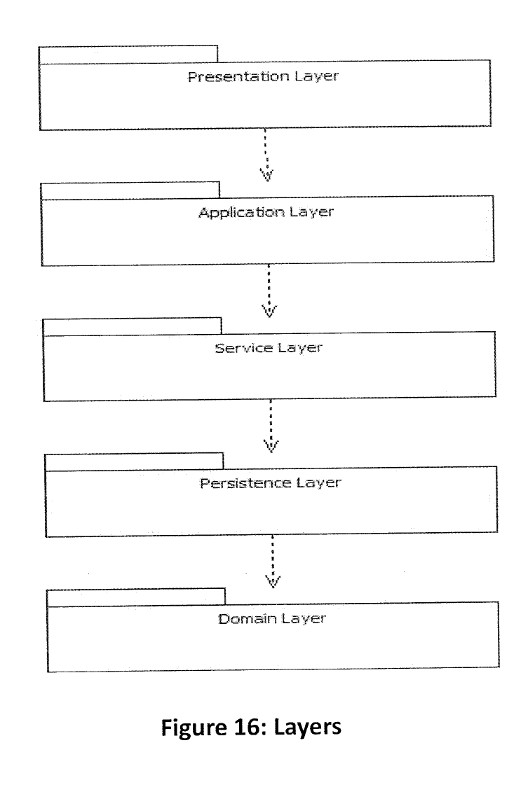

Overall, the CKS system is architected as a layered system. FIG. 16 illustrates the layers and their dependencies. The responsibility and implementation technology is described in the following sections.

All functionalities of the system are horizontally divided into the layers shown in FIG. 16.

The responsibility of each layer and their main components is illustrated in FIG. 16.

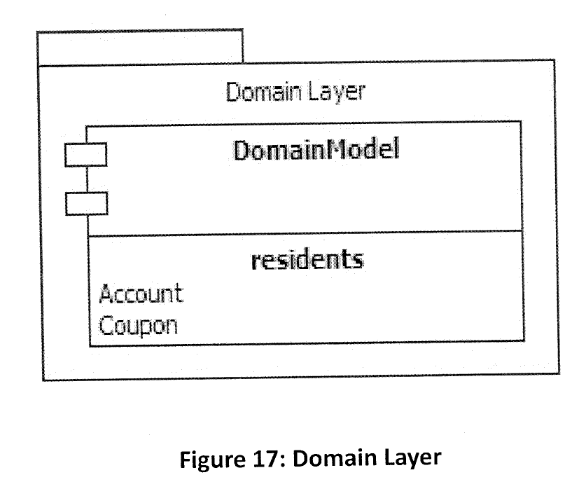

The domain layer in FIG. 17 shows a domain model created for CKS system. All necessary entities with their attributes and relationships are captured in the domain model. Example entities are: Account, End User Profile, Merchant Profile, Coupon, etc. The entities are implemented using the EJB 3 Entity Bean technology, a component architecture for the development, deployment of component-based distributed application using the Java language.

The domain layer has an important technical responsibility which is to provide a caching layer for the database server. The cached objects will be replicated across all nodes in a cluster to provide a consistent view of the system state.

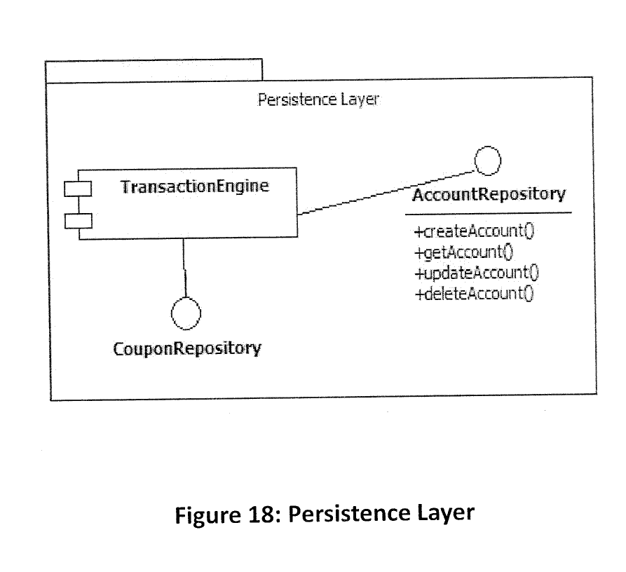

FIG. 18 illustrates that the transaction engine is located in the persistence layer, which implements various data accessing interface. Like the AccountRepository and CouponRepository shown in FIG. 18, these interfaces define how the entities in the domain model can be manipulated by the services layer. As FIG. 18 shows, an AccountRepository may provide a method than can create, get, update and delete an Account entity. The transaction engine is implemented using EBJ 3 Stateless Session Bean and are remotely accessible.

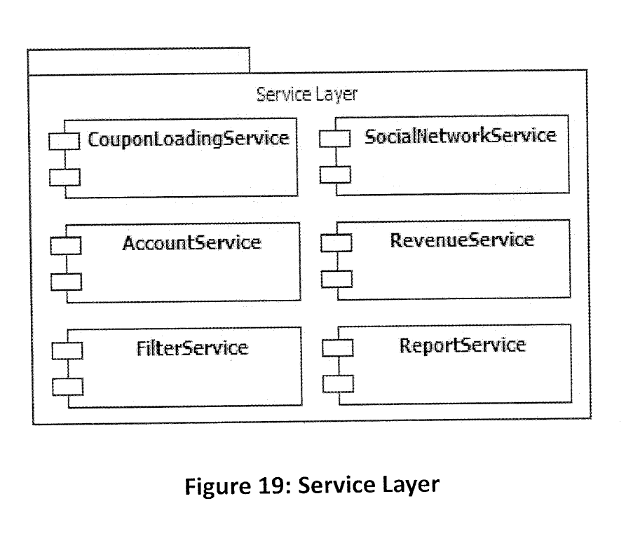

FIG. 19 shows that the components in the service layer implement all business rules; it is the core of the system. The service components access the persistence layer to save the data into the database and provide services to the application layer to integrate with other systems.

The service components are implemented using EJB 3 Stateless Session Beans and are remotely accessible.

Transactions and security rules are applied to service layer components.

The components in the application layer are integration modules or provide user interface to users. These components are running in Java EE Web Container, and are implemented on Servlet based framework.

The presentation layer contains artifacts used to create the user interfaces. In CKS, all user interface are web based, so HTML, CSS and JavaScript technology will be used intensively.

FIG. 20 illustrates the network topology of the CSK system. The core servers are all isolated in a DMZ zone and cannot be accessed from external servers.

At the platform level, the CSK system will utilize the standard security services provided by the Java EE middleware. The security infrastructure provides a mechanism to declare services that can be accessed by a client with specific roles. Services can be accessed by the clients that passed the authentication and with authorized permissions.

For example: Coupon feeding provider requests to connect to the coupon offers maintenance service provided by CKS. When CKS receives the connection request, Onix will be asked to authenticate. CKS assures that coupon feeding provider passed the authentication process with a CouponFeedingProvider role. If the authentication is failed, the connection request will be rejected.

End user Console, Merchant Console and Back Office in the CKS system will be accessed through a web browser. All sensitive data transferred between the CKS system and the web browser will transport through a SSL 128/256 tunnel. In addition, Back Office access is protected by IP address filtering. IP address filtering is a mechanism that prevents IP packets originating from unauthorized IP addresses. That means any system accessing to Back Office must be an authorized system with authorized IP address.

CKS is a flexible and expandable system. CKS can accept 3^{rd} party system connections with their specific integration protocols and security requirements. 3^{rd} party system providers should provide their integration protocols and security requirements. CKS will comply with their requirements.

All other sensitive communications between CKS and external systems not mentioned here will go through a SSL 128/256 tunnel, unless specific requirements are provided by the external system providers.

For user password protection, at the first time users enter their password to the web form and submit it to CKS, CKS generates a salt, saves it and appends it to the clear text password, then gets the hash code of the salted password and saves it to the database. When users try to login to the system, the system will get the saved salt, append it to the password, get the hash code of the salted password and compare it with the one saved in the database to authenticate the user.

At the application level, CKS utilizes a role based access control design. The role based access control can limit users to access the application functions, or prevent unauthorized users to access the applications. The permissions are predefined in the system. An administrator can create a new role and assign an appropriate permission to the new role. When the administrator added a new user, an appropriate role will be assigned to the new user. Through this assignment process, users get permission to access the system based on their role.

Thus, in U.S. patent application Ser. No. 12/944/005, the teachings of which are incorporated herein by reference, a system and method is disclosed where a base station provides a user redeemable coupon account for a user. A coupon settlement provider is set up for settling a redeemed coupon and a redeemable coupon feeding provider server is coupled to the base station for delivering a redeemable coupon from the server to the base station and into the account of the user. A point of sale merchant, who can be a retailer, wholesaler, on-line seller, etc. is coupled to the base station. Coupon verification is associated with both the point of sale merchant and the base station for verifying that a redeemable coupon is associated with a purchase made by the user at the point of sale merchant and coupon redemption and settlement is provided at the base station for informing both the server and the settlement provider of receipt from the merchant at the base station of a verified processed redeemed coupon. The base station may be provided with an interface with a debit or credit card account of the user to associate the same with the user redeemable coupon account.

In our patent application Ser. No. 12/944,005, a proposed CKS core system architecture is illustrated in FIG. 2 and described in numbered paragraphs 0039 et seq. In the drawings in this application, and in application Ser. No. 12/944,005, CASHKLICK and CKS (abbreviation for CASHKLICK) are trademarks of Cashklick, Inc. of Sunnyvale, Calif., assignee of all right, title and interest in and to the subject matter of both application Ser. No. 12/944,005 and this application.

The original Core platform disclosed in patent application Ser. No. 12/944,005 was designed to handle the process of user registration, coupon feeding, coupon redemption and coupon settlement. The original Core platform requires a high performance server farm and high efficient network provider.

As will be discussed herein below, Core G2 transfers the coupon redemption and settlement responsibilities to coupon processor partners such as Inmar, Inc. Core G2 is an innovated system to send an identifier through payment system network to trigger coupon redemption at Point of Sales at checkout and/or receive payment data from the payment system network for data reconciliation purposes when coupon redemption is triggered by an identifier other than payment cards such as loyalty store card numbers, phone numbers, etc. at Point of Sales at checkout. Core G2's main role is to synchronize Cashklick user databases with databases sitting inside the Payment Service Provider (PSP) network. Core G2's main role is to respond to PSP's requests about Cashklick user accounts and initiate data requests to PSP.

Inmar, Inc. is a leader in the field of processing coupons for manufacturers and others. The following abbreviations used in the drawings refer to the following:
API: Application Programming Interface
BO: Back Office
Core G2: Name of the CKS card system depicted in this application
DB: Database
CAN: Cashklick Account number. It is the Cashklick user ID to identify users throughout the system
Inmar: A business partner of Cashklick. Onix and MDot network are Inmar's products. ONIX is an on-line information exchange. MDot Network is a network set up for clearing coupons and reimbursing the same
PAN: Primary Account Number
POS: Retailer Point of Sales
PSP: Payment Service Provider. Also called acquirer/processor
Publix: Internal name for CKS publishing platform including mobile application
Sync: Synchronize, synchronized or synchronization
User: CKS end-user
   As seen in FIG. 21, the schematic illustration shows what is needed to enable coupon redemption through debit/credit card at checkout and/or receive both coupon redemption data and payment data:
Users enroll payment card numbers (stored at Core G2 102) as well as any other identifier such as loyalty card numbers, phone numbers, etc. at Station 100. Once registered users select/clip coupons at station 100. Clipped coupons at Station 100 are sent first to Inmar ONIX 101 which send an acquisition message to M-Dot Network 103. MDot Network is Inmar's retailer network (this is an example only and this system works with any coupon networks) to enable coupon redemption at retailer POS 104 and send coupon redemption data back to station 100.
Enrolled payment card numbers stored at Core G2 102 are sent with their associated Cashklick Account Number (CAN) to PSP 105 to trigger coupon redemption and/or receive payment data when coupon redemption and/or receive payment data when coupon redemption is triggered by an identifier other than payment card number such as loyalty store card numbers, phone numbers, etc. in order to do data reconciliation (coupon redemption data with payment transaction data).

### Option #1: Transaction Flow When Coupon Redemption Is Triggered By Payment Card Number At POS

User swipes payment card at checkout
Total amount is computed and displayed
Authorization request using standard XML message is sent to PSP 105 by POS system at retailer 104
   If NOK (NOT OK) then PSP 105 sends a standard reply message to retailer 104
   If OK then PSP 105 sends request to Core G2 102 in slave Database (DB) to check if payment card exists in slave DB
      If card does not exist in Slave DB then PSP 105 sends standard reply message to POS at retailer 104
      If card exists in slave DB then PSP 105 copies Cashklick Account Number (CAN) (example of format of CAN: $CAN=“CKXXXXXXXX”, X being numbers or letters) into the “retailer data” field within the reply message (alternatively CAN can be copied in another data field in the reply message) then PSP 105 sends standard reply message to retailer 104 and updates log for reporting to Core G2 102 (reporting is not compulsory)
Retailer POS system 104 receives reply message from PSP 105
Retailer POS system 104 does a logic check (as usual) to check if transaction is still on queue
   if transaction is deleted in the POS system 104 then end of transaction
If transaction is not deleted then there is a standard matching between PSP reply message and POS system
   If reply is NOK then end of transaction
   If reply is OK
      If $CAN is “NULL” then transaction continues as usual
      If $CAN is not “NULL” then POS system 104 sends a request including CAN in the message to coupon network 103 (the coupon network is Onix and MDot Network in this example). Coupon processor 103 then sends the redemption message back to POS system 104 and sends coupon redemption data back to station 100. Final amount is computed by POS
Transaction continues as usual. Retailer POS system 104 sends an authorization capture to PSP 105 (this authorization can be delayed)

### Option #2: Transaction Flow When Coupon Redemption is Triggered by an Identifier Other Than Payment Card Number

User gives cashier (or scan) a loyalty store card or any other identifier linked to station 100 other than payment card to trigger coupon redemption at retailer POS 104
POS system at retailer 104 sends a request to coupon network 103 (the coupon network is MDot Network and Onix in this example). Coupon processor 103 then sends the redemption message back to Retailer POS system 104 and also sends coupon redemption data back to station 100 through Onix 101
Total amount after coupon is computed and displayed at Retail POS 104
User swipes payment card for payment
PSP authorizes payment transaction
PSP sends to Core G2 102 the payment transaction data (this can be real time or send by batches every x days)
Station 100 and Core G2 102 do a reconciliation of coupon redemption data and payment transaction data for statistics purposes and knowledge building. These data can be used for triggering other reward and loyalty programs such as Financial Institution-funded, Merchant-funded or Brand-funded cash back programs.
   Integration between PSP 105 and Core G2 102
   The Core Slave DB is residing in the PSP network environment 105, and responds to all payment card inquiries to check if that card is affiliated to a Cashklick account number (CAN). This core slave database can either belong to Cashklick or to PSP.
   The account number inquiry is taking place inside the PSP environment and no external network communication is required. This will reduce the Slave DB response time. Alternatively account number inquiries can be made to an external network.
   For coupon redemption transactions triggered by an identifier other than payment card numbers, PSP 105 sends payment transaction data to Core 102 Master database upon request of Core G2 102.
   Since the Core Slave Database server is residing in PSP environment, the database synchronization with Core master Database should go through a dedicated secure VPN and secure XML service.
   FIG. 22 is an Example of Core Master Database Synchronizing with the Core Slave Database.

### Database

According to PCI DSS FIG. 23 illustrates the main components of a (Payment Card In Quality-Digital Signature Standard) CORE Master System, requirements, PAN (Primary Account Number) is salted and hashed and stored in the PAN Database, the salt must not be stored in the same database. The salt is stored in the Main DB.
Main DB—it stores salt and other Core Master's data.
PAN DB—it stores hashed PAN.
Other encryption systems to encrypt and decrypt payment card numbers i.e. PAN can be used in Core Master database.

### Data Access Component

The data access component is designed to provide an easy access to the data that are stored in multiple databases.

### Back Office

The Back Office is a web-based console that provides management features to Core G2 system administration.

### Publix Integration

Publix is the publishing system of Cashklick. It is interfaced with Core G2. Publix includes all the back end tools to manage coupon publishing, campaign management and all the front end tools such as mobile application or websites, etc. to distribute coupons to users.
Here are some functionalities of Core G2 integrated with Publix:
Payment Card Change—this is a web page that allows Publix users to add/change their payment card. This page will be embedded in Publix mobile apps.
User Sync.—This is a service that will be called by Publix whenever a user changes his/her user information, such as name, gender, age, loyalty cards, phone number, etc.
Account Number Generation—When the user signs up on Publix mobile app or another medium, Publix will call this service to get a unique Cashklick account number (CAN) and associates this number with the registered user. The CAN allows the identification of the user across all Cashklick related systems, including Publix, Core Master, Core Slave, etc.

### Core Slave Sync.

This is a process that sends user update data to Core Slave system. Whenever a user in Core Master changes his/her payment card, the new data will be sent to Core Slave system.
FIG. 24 depicts an example of a deployment topology of a Core Master system.
FIG. 25 shows the main components of a Core Slave system

### Database

According to PCI DSS (Payment Card Industry-Digital Signature Standard) requirement, PAN (Primary Account Number) is salted and hashed and stored in the PAN Database; the salt must not be stored in the same database. The salt is stored in the Main DB.
Main DB—it stores salt and other Core Slave data.
PAN DB—it stores hashed PAN.
Other encryption systems to encrypt and decrypt payment card numbers i.e. PAN can be used in Core slave database.

### Cache

The Core Slave system is mostly a read system. A cache can largely reduce the access to database and improves the performance of the system. Non-hashed PAN and Cashklick Account Number pair may be cached in the cache system to eliminate the need of hash code calculation and dramatically reduces the response time of the system.

### Data Access Component

The data access component is designed to provide easy access to the data stored in multiple databases.

### Core Master Integration

Account Sync. Service—this service is designed to be called by Core Master System to keep the core Slave system data up to date.

### PSP Integration

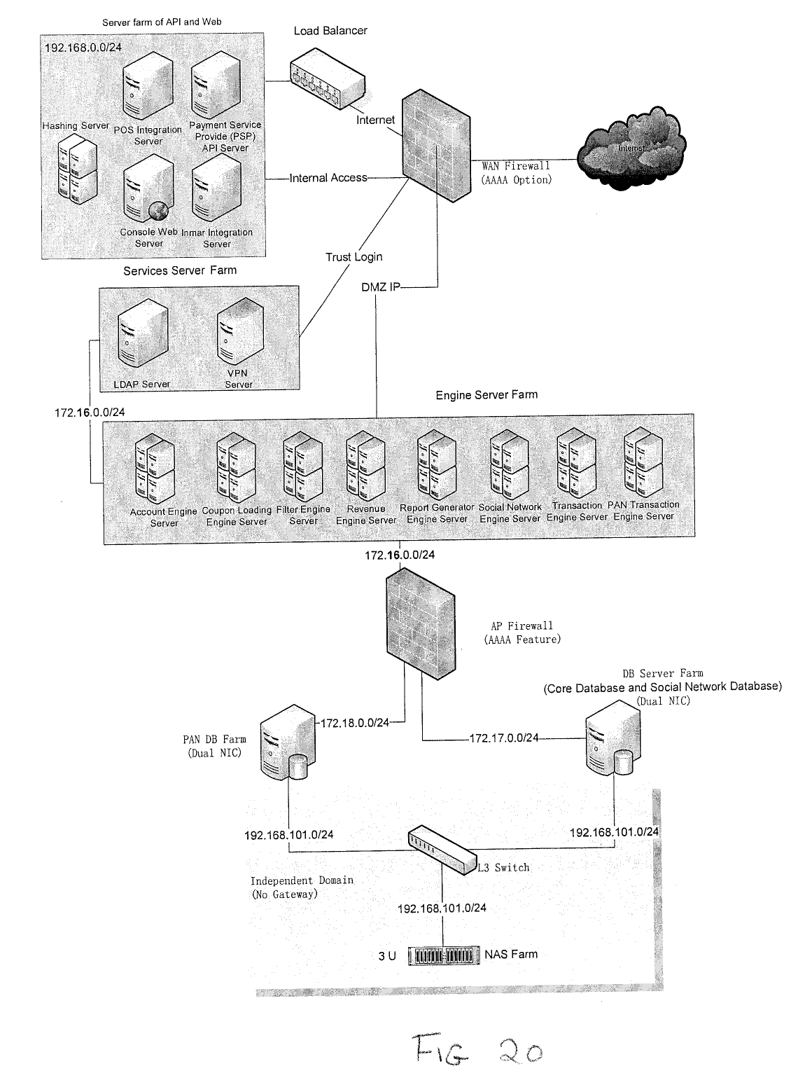

PSP API (Application Programming Interface)—the PSP will call this API to get Cashklick Account Number with a PAN and/or send payment data to Core Master database.
FIG. 26 depicts an example of a deployment topology of a Core Slave system
All new users are registered through Cashklick's Publix platform. The User's profile information (excluding Payment Card) is stored in Publix's database. New and updated user's information will be synchronized with Core Master Database. Data will be sent by Publix to Core Master Database. Core Master will insert a new user data to Core Master Database if the user is a new user. If the user is an existing user, Publix will also send the updated information to Core Master Database.
The following is a non-exhaustive list of user information that will be synchronized to the Core Master DB.
First name
Last name
Zip code
Gender
Retailer Store loyalty cards
Phone numbers
Publix status
Cashklick Account Number (CAN)
   After the core Master Database and Publix have synchronized, Core Master Database will broadcast the new or updated user's information to the Core Slave Databases that are residing in PSPs' environment. FIG. 27 shows Data Sync-Up between Core Master DB and Core Slave DB.
1. Core Master DB synchronizes with Core Slave DB (including Cashklick Account Number)
2. Data exchange between PSP 105 and Retailer POS system 104
3. Core Slave reports system status and/or submits real time or not real time reports back to Core Master

### A. Database Synchronization

The synchronization of Core Master Database and Core Slave Database will occur when user's information are added or updated (including deleted). The following activities (non-exhaustive list) will trigger the database synchronization.
New user profile inserted to Core Master Database
User profile information updated on Core Master Database
User profile removed from Core Master Database
   The Core Slave Database only needs partial information from Core Master Database. Therefore, only the required user information will be sync up with Core Master Database. The following user's information (non exhaustive list) will be synchronized from Core Master Database to Core Slave Database.
Cashklick unique Account Number
Card brand ID
PAN number (Hashed or not Hashed, in full or partial)
PSP can add additional data such as last access timestamp, etc.

### B. Data Update Log

All user data change activities have to be recorded on the change log. The following information (Non-exhaustive list) will be captured and recorded on the log file for audit or reporting purposes.
Cashklick unique Account Number
Activity type (New, Update, Delete)
What data was changed?
Timestamp
   The data update log should be created on both Core Master and Core Slave. When Core Master has received update from Publix and sent update to Core Slave, Core Master will record the transaction on log file. The Core Slave also records the transaction log when it receives update from Core Master.
   The data exchange between PSP and retailer POS system is maintained by PSP. PSP will send the following user information to retailer through the PSP communication channel.
Cashklick Account number
Additional info if needed such as Card brand ID timestamp, etc.
   User data access activities in data exchanges between PSP and retailer POS system can be recorded on an access tracking system or data access log. The following information (non-exhaustive list) should be recorded on the tracking system:
Cashklick Account Number
Retailer ID (if possible)
The access timestamp

### A. Back Office

Here is a non-exhaustive list of features available in Core G2

### End User List

Synchronized end user list from Publix system. The Core G2 administrator can view and query the end user information. However, information cannot be modified and it is available for viewing.

### Payment Card

The Core G2 administrator can view and query the payment card information (including end user CAN).
Overview and query payment card
Payment card history
Automatically active or inactive payment card per Publix's request
Automatically prevent inactive payment card information to be sent to PSPs

### Access List

The core G2 administrator can maintain the access list which can be accessed to the Core G2 platform.

### System Tracking

The Core G2 administrator can view and query the system data changes and the transactions tracking log.

### BO User Management

The Core G2 administrator can view and query the BO user information. Also, the administrator is able to perform administrator account maintenance and access roles assignment.

### View and Query BO Users

### Create New BO User

### Update BO User

### Reset BO User Password

### BO User Roles Assignment

### Role Management

The Core G2 administrator can view and query the system roles. Also the administrator is able to maintain the system roles and system permissions assignment to roles.

### View and Query System Roles

### Maintain System Roles

### System Permission Assignment for Roles

### Permission Management

The Core G2 administrator can view and query the system permissions. The system permissions are tied to development layer.
B. Publix Integration (through APIs)
Core G2 provides Application Programming Interfaces (APIs) and the embed web application to support the Publix system.
Generate Account Number (through APIs)
When an end user registers on Publix system via mobile application, the Publix system will send the request to Core G2. Core G2 integration APIs will generate the CAN to Publix system.
Maintain End User Profiles (through APIs)
When an end user edits the user profile (or user profile is edited by Publix BO administrator), Publix system will push these changes to Core G2 system. Core G2 system will store those changes to Core G2 Master database.
Payment Card Status Sync (through APIs)
When payment card is activated or inactivated by Publix BO administrator, Publix system needs to synchronize to Core G2 system.
Payment Card Update (through Web Application)
The end user can edit/update the payment Card by accessing the web application on mobile embedded browser.

### Add New Payment Card

### Update the Old Payment Card

### C. Data Synchronization

Core G2 needs to synchronize the end user information with Publix system and PSP system (core Slave).

### Publix System Section

When an end user registers on Publix system, Publix system will send a request to Core G2 through the Publix Integration. Core G2 will store the lend user information on Core G2 database and respond to Publix system with user Cashklick account number. When end user or Publix BO administrator edits the end user profile, Publix system will sync-up the changes with Core G2 system.

### Core Slave Section

After Core G2 Master has synchronized with Publix system, Core G2 Master will synchronize the current data change to Core Slave database.

### Core Slave Features

Here is a non-exhaustive list of Core slave features:
Data Synchronization with Core Master
Cache Data to Cache Server
Provide PSP APIs
Data Log Update
Send statistic report to Core Master in non-busy schedule
   The users herein can be cardholders from issuing banks from co-branded banks or from financial institutions or the like. The cards may be debit cards, credit cards, pre-paid cards, etc. The point-of-sale may be a retailer or wholesaler at a physical location, or on-line.
   The coupon verification and status determination may be carried out by any suitable acquirer/processor, coupon processor or financial institution. If the user's card is dematerialized for any reason, the user can make a mobile payment at checkout, eq., by phone, Google Wallet, Visa Mobile payment, etc.

While the apparatus and method have been described in terms of what are presently considered to be the most practical and preferred embodiments, it is to be understood that the disclosure need not be limited to the disclosed embodiments. For example, although the system and method uses a debit or credit card as an identifier at the point of sale, other payment means may be used such as PDA, cell phone, etc. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A system for redeeming coupons comprising:
a base station providing a user redeemable coupon account for a user;
a coupon settlement provider for settling a redeemed coupon;
a point of sale merchant coupled to said base station;
coupon verification means associated with both said point of sale merchant and said base station for verifying that a redeemable coupon is associated with a purchase made by said user at said point of sale merchant; and
coupon redemption and settlement means provided at said base station for informing both said server and said settlement provider of receipt from said merchant at said base station of a verified processed redeemed coupon.

2. The system of claim 1 including providing said base station with an interface with a debit or credit card account of the user and associating the same with the user redeemable coupon account.

3. A method for redeeming coupons providing the steps of:
Setting up a user redeemable coupon account for a user at a base station;
Setting up a redeemed coupon settlement provider;
Delivering a redeemable coupon from a redeemable coupon feeding provider server to the base station and into the account of the user;
Processing said coupon redeemed at a point of sale merchant by the user after verification of said coupon by said base station when said verified coupon is redeemed at said point of sale by said merchant and returned to the server, and informing both said settlement provider and said server of receipt of said verified processed redeemed coupon.

4. The method of claim 4 wherein the step of setting up said coupon account includes the step of associating said coupon account with a debit or credit account of the user.

5. In a system for redeeming coupons offered by a brand owner of a product or service, the system comprising:
A redeemable coupon feeding provider server adapted to receive a redeemable coupon offer from said brand owner;
A base station providing a user redeemable coupon account for a user associated with a debit or credit card of the user adapted to receive a redeemable coupon offer generated by said server and delivered to said base station for deposit into the account of said user;
A coupon publisher adapted to receive a redeemable coupon offer from said server and transfer a published redeemable coupon to said server for transfer to said base station; and
A point of sale merchant adapted to receive a redeemable coupon from said server.

6. The system of claim 5 including a coupon settlement provider and said base station being adapted to provide said merchant with verification of said coupon in the name of said user, said base station being adapted to inform both said coupon settlement provider and said server when said redeemed verified coupon is sent by said merchant to said base station.

7. In a method for redeeming coupons offered by a brand owner of a product or service, said method comprising the steps of:
Setting up a redeemable coupon account for a user at a base station associated with a debit or credit card of the user;
Publishing a redeemable coupon;
Delivering said published redeemable coupon from a redeemable coupon feeding provider server to said base station for deposit into the account of said user after receipt of said published redeemable coupon; and
Redeeming said coupon for the benefit of said user at a point of sale merchant.

8. In the method of claim 7 wherein said steps of publishing said redeemable coupon includes the steps of said server transmitting said coupon offer received from said brand owner to a coupon publisher for publishing of said redeemable coupon.

9. In the method of claim 7 including the step of providing said merchant with redemption of said coupon in the name of said user when said redeemed coupon is sent by said merchant to said base station after verification at said base station that said coupon is associated with or purchase by said user at said merchant.

10. In the method of claim 9 including the steps of advising said server of said redemption.

11. A method for redeeming coupons providing the steps of:
Setting up a user redeemable coupon account for a user at a base station;
Delivering a redeemable coupon from a redeemable coupon feeding provider server to the base station and into the account of the user; and
Processing said coupon redeemed at a point of sale merchant by the user when said coupon is redeemed at said point of sale by said merchant after verification that said coupon is associated with said sale by said base station.

12. In the method of claim 9 including the steps of advising said server of said redemption.

13. A system for redeeming coupons comprising:
coupon redemption means associated with a user for applying a value-bearing coupon to a purchase of an asset by said user at a point-of-purchase;
coupon verification means associated with both said point-of-sale purchase and said user for verifying the cost of said asset purchased by said user at the point-of-sale and the value of said coupon being redeemed by said user; and
status means associated with the coupon verification means for either approving said point-of-sale purchase and redemption of said coupon or denying the same.

14. The system of claim 13 including providing said base station with an interface with a store card issued by a retail store to said user having at least one redeemable coupon associated with said store card.

15. The system of claim 14 wherein said base station includes reconciling means for reconciling the coupon redeemed with the payment by said user at said point of sale with the payment card on file at said base station to determine if said payment card on file was used.

16. The system of claim 13 wherein said coupon verification means and said status means is provided by a payment service provider.

17. The system of claim 13 said user includes user purchase implementing means owned by said user used at said point-of-purchase to activate said coupon redemption or denial of same.

18. The system of claim 17 wherein said user purchase implementing means is a credit card.

19. The system of claim 18 wherein said user purchase implementing means is a debit card.

20. The system of claim 18 wherein said user purchase implementing means is a portable personal digital assistant.

21. The system of claim 20 wherein said portable personal digital assignment is a mobile phone.

22. The system of claim 21 wherein a virtual wallet of the user is associated with said mobile phone allowing the user to pay at said point-of-purchase by actuating said wallet.

23. The system of claim 17 wherein said user purchase implementing means is a prepaid credit card.

24. A method for redeeming coupons comprising the steps of:
applying a value-bearing coupon owned by a user to a purchase of an asset by said user at a point-of-purchase;
verifying the cost of said asset purchased by said user at the point-of-sale and the value of said coupon being redeemed by said user; and
either approving said point-of-sale purchase and redemption of said coupon or denying the same.

25. The method of claim 24 including providing said base station with an interface with a store card issued by a retail store to said user having at least one redeemable coupon associated with said store card.

26. The method of claim 25 including reconciling means for reconciling the coupon redeemed with the payment by said user at said point of sale with the payment card on file at said base station to determine if said payment card on file was used.

27. The method of claim 24 wherein the sep of verifying is provided by a payment service provider.

28. The method of claim 27 wherein said purchase is implemented by a user at said point-of-purchase by means of a credit card.

29. The method of claim 27 wherein said purchase is implemented by a user at said point-of-purchase by means of a debit card.

30. The method of claim 27 wherein said purchase is implemented by a user as said point-of-purchase by means of a portable personal digital assistant.

31. The method of claim 30 wherein said purchase is implemented by use of a mobile phone.

32. The method of claim 31 including the step of providing said mobile phone with a virtual wallet of the user is allowing the user to pay at said point-of-purchase by actuating said wallet.

33. The method of claim 28 wherein the step of using a credit card includes the use of a prepaid credit card.
